(19) United States
(12) Patent Application Publication
(10) Pub. No.: US 2008/0226863 A1
(43) Pub. Date: Sep. 18, 2008

(54) Glass Enamel Screen Printing Composition

(76) Inventors: Robert Prunchak, East Windsor, NJ (US); Wojciech Wilczak, Jersey City, NJ (US)

Correspondence Address: BASF CATALYSTS LLC, 100 CAMPUS DRIVE, FLORHAM PARK, NJ, 07932, US

(21) Appl. No.: 11/687,170

(22) Filed: Mar. 16, 2007

(51) Int. Cl. C03C 8/14

(52) U.S. Cl. 428/98; 501/17; 65/64

(57) ABSTRACT

Glass enamels, methods of manufacture, methods of application, and articles including glass enamels applied thereto are described. According to one or more embodiments, the glass enamel comprises a glass frit; a vehicle comprising a polymeric energetic binder; and an oxidizing agent. In one or more embodiments, the glass enamels may or may not include a pigment and can be applied to glass sheets such as windshields for automobiles or liquid crystal display glasses.

### TECHNICAL FIELD

Embodiments of the invention relate to glass enamel screen printing compositions, methods of manufacture and methods of application to glass substrates.

### BACKGROUND

Automotive windshields typically comprise two sheets of glass bonded to a pliable interlayer usually made up of polyvinyl butyrate (“PVB”). The two sheets of glass are usually curved, or otherwise shaped, during the manufacturing process. A coating, such as glass enamel ink, may be added to one or more of the glass surfaces. The coating commonly functions to obscure and prevent UV light degradation of the organic adhesives, which adhere the glass to a car chassis. Further, the coatings may also function as antennae or resistance heaters when made of conductive materials.

After application to the glass, and firing the part to the proper temperature, it is desirable for the glass enamel ink composition to develop a substantially non-porous structure having uniform opacity and color. Furthermore, during the firing (bending process) it is desirable that the glass enamel does not transfer onto any other glass surface. The glass enamel ink should also be characterized as having sufficiently long shelf life, i.e. good viscosity stability while the enamel is stored in its original, unopened container.

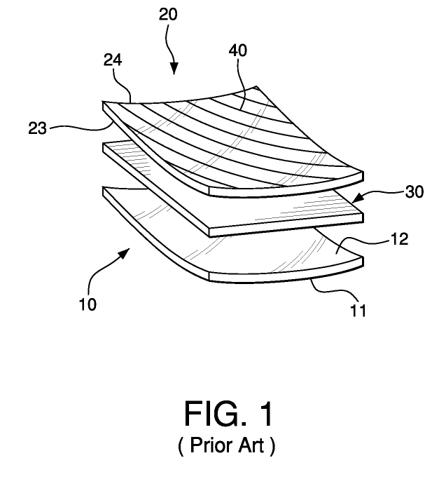

Various compositions of glass enamel ink and methods of application are known in the art. One such glass enamel ink by first forming a glass enamel ink layer of a glass enamel ink composition on top of a first glass sheet. The next step consists of stacking the first glass sheet, with the glass enamel ink layer printed thereon, on top of a second glass sheet, thereby exposing the glass enamel ink layer to ambient air atmosphere. The third step involves firing and shaping the stacked glass sheets in a bending lehr. The firing process which is used to bend the glass into the proper shape, also decomposes organic binders in the glass enamel ink, melts the glass frit particles, develops the proper microstructure and results in an enamel ink finish on the glass sheet. After allowing the stack to cool, the glass sheets are separated so that an interlayer may be inserted. The glass sheets are rejoined and bonded to the opposite sides of the interlayer, resulting in a single, multi-layer glass composite. FIG. 1 shows the finished structure, which comprises a first glass sheet 10 having a first surface 11 and a second surface 12, a second glass sheet 20 having a third surface 23 and a fourth surface 24, an interlayer 30 disposed between the first glass sheet 10 and the second glass sheet 20 and a glass enamel ink layer 40 disposed on the fourth surface 24.

There is interest within the industry to develop a glass enamel ink that could be printed on the second surface 12 position, that is, between the glass sheets instead of the fourth surface 24 position facing the inside of the vehicle compartment. A benefit of locating the enamel between the two glass sheets or substrates is that the enamel can visually hide any electrical connections that may be a part of the interlayer, such as wires or busbars. Another benefit is that the enamel is protected from the environment, i.e. acid rain, detergents or cleaners that may tend to degrade the enamel over time.

Methods to dispose glass enamel inks on the second surface often involve a dual-firing process. This known method of application requires printing the glass enamel ink onto a first glass sheet and firing the first glass sheet to thermally decompose the binders while remaining substantially flat. A second glass sheet is then stacked on top of the first glass sheet. The stack is then heated and shaped to the desired curvature or shape. However, a disadvantage of this process is that the dual firing process to thermally decompose the binders present in the enamel is expensive.

Another method for obtaining a glass with the enamel in the second surface position while using only one firing is to utilize a press bending furnace such as those offered by Glasstech Incorporated, Perrysburg, Ohio. In this type of furnace, the two sheets of glass are fired without stacking. Each glass is exposed to the atmosphere of the lehr and any organics are able to burnout. Each sheet of glass is then press formed onto its own separate mold. After the parts have been cooled (annealed) they are bonded to an interlayer sheet. While this method is very good at producing precision parts, a manufacturer can only use it if they have a press bend furnace. Such a furnace represents an extremely high capital investment.

To reduce the high cost of a second firing step, another glass enamel ink application technique known in the art utilizes a low temperature heat cycle during the first firing step. Although the low temperature heat cycle reduces the cost of applying this glass enamel ink, it limits the variety of glass enamel inks which can be successfully used. Currently used glass enamel inks fail to oxidize completely and organic components remain between the two glass sheets, despite the second higher temperature firing step. This gives rise to the possibility of transfer of the glass enamel ink onto the second sheet. Further, the lack of oxidation often results in a porous finish having poor opacity and irregular coloring.

Changes to the glass enamel composition have been attempted, including adding oxygen-releasing agents to the glass enamel ink composition. Although aiding in oxidation, the oxidizing agents cause difficulty in printing because they can compromise the viscosity of the glass enamel ink. As previously mentioned, there is industry interest to develop an enamel layer in between the glass sheets, in the second surface position. Further, there is a need for a glass enamel screen printing ink that can be applied and affixed by utilizing a first low temperature heat cycle for drying, followed by a traditional higher temperature firing cycle to shape the glass with the finished part having a substantially non-porous and uniformly opaque finish. It would be desirable if an enamel paste could be provided that has suitable shelf-life when stored in its original unopened containers and stored at reasonable temperatures, for example, less than about 40° C.

### SUMMARY

One or more embodiments of the present invention provide glass enamel compositions that include a polymeric energetic binder, which, during subsequent heat treatment of substrate, oxidizes completely. Furthermore, according to one or more embodiments, the glass enamel can be applied using a first low temperature heat cycle to dry the applied enamel followed by a traditional higher temperature heat or firing cycle to shape the glass with the finished part having a substantially non-porous and uniformly opaque finish. According to one or more embodiments of the invention, the enamel paste itself should have suitable shelf-life when stored in its original unopened containers and stored at reasonable temperatures, for example, less than about 40° C.

Articles such as glass windshields and liquid crystal display glass can be manufactured using the glass enamels described herein. Further, the glass enamels described herein may also be applied to the fourth surface position of glass composites.

In accordance with one embodiment of the present invention, a glass enamel comprises a glass frit, a vehicle, which contains one or more polymeric energetic binders, and at least one oxidizing agent. According to one or more embodiments, the energetic binder and the oxidizing agent are each present in amount of about 0.1 to 40% by weight. In one or more embodiments, the glass frit is a crystallizable frit present in an amount of about 30% to 90% by weight. In certain embodiments, the glass enamel may include up to about 30% by weight of nucleating agents such as seed crystals, and other resins may be present in the composition, up to about 10% of the total resin content. In one or more embodiments, the composition may include up to about 40% by weight of pigment to provide an enamel ink composition and one or more stabilizers.

In accordance with an embodiment of the invention, the polymeric energetic binder is characterized as a resin which loses about 50% or more of its weight when its temperature reaches about 2750° C. Further, this energetic binder comprises nitrogen-containing and/or fluorine-containing moieties, such as nitro, azido, nitramino, fluoro, etc. Examples of polymeric energetic binders include but are not limited to nitrocellulose, glycidyl azide polymer (GAP), poly (3-nitratomethyl-3-methyl oxetane), poly (3,3-azidomethyl oxetane), poly (3-azidomethyl-3-methyl oxtane), poly(glycidyl nitrate), poly(vinylnitrate), polynitrophenylene, nitramine polyethers, and nitrated polybutadienes, and combinations thereof.

According to one or more embodiments of the invention the oxidizing agent comprises peroxides, chlorates, perchlorates, nitrates, permanganates, and combinations thereof. An example of a particular oxidizing agent comprises zinc peroxide or a bismuth salt of nitric acid.

According to one embodiment of the invention, the glass enamel includes nucleating agents to control the crystallization of the crystallizable frit.

In other embodiments of the invention, the glass enamel may also include resins, in addition to the polymeric energetic resin, such as ethylhydroxyethyl cellulose (EHEC) and hydroxypropyl cellulose. According to one or more embodiments, these additional resins are present in an amount below about 10% of the total resin content. The addition of these additional resins may enhance film forming and rheological behavior of the glass enamel.

In another embodiment of the invention, stabilizers such as boric acid, phosphoric acid, hydrochloric acid, nitric acid and sulphuric acid may also be included to improve the viscosity stability of the glass enamel.

In yet other embodiments of the invention, the glass enamel screen printing ink also includes a pigment. One or more embodiments include the use of pigments having average particle sizes ranging from about 100 nm to 5 μm in diameter. Other embodiments do not utilize any pigment to achieve a transparent or translucent finish.

In other embodiments of the invention, a refractory filler may be included to adjust certain properties of the glass enamel screen printing ink such as firing temperature, color, coefficient of thermal expansion, crystallinity and roughness. According to one or more embodiments, the refractory filler has a particle size which prevents adhesion between the glass sheets. For example, the refractory fillers used in some embodiments have a particle size less than 75 μm. Other embodiments utilize refractory fillers with particles with different sizes, so long as approximately 20% of the mass of the particles is larger than 15 μm.

In another aspect of the present invention, methods of manufacturing a glass composite article are provided. According to one embodiment, a glass composite having a glass enamel layer may be manufactured by first producing a glass enamel ink and screen printing it onto a first glass sheet. In one embodiment, the glass enamel is allowed to dry by exposing it to temperatures of about 200° C. or for a period of several minutes. According to one or more embodiments, the first glass sheet, and the glass enamel ink disposed thereon, is allowed to cool to room temperature. Placement of a second glass sheet on top of the first glass sheet disposes the screen printed glass enamel between the first and second glass sheets. The first and second glass sheets and glass enamel layer are then simultaneously fired and shaped through a bending lehr. Separation of the two glass sheets and insertion of a pliable interlayer proceeds the firing and shaping step. The glass sheets can then be rejoined and bonded to the interlayer. The structure of the resulting glass composite has a glass enamel layer disposed in the second surface position. Further, the glass enamel layer possesses a substantially non-porous and uniformly opaque finish.

Another aspect of the invention pertains to an article having a first glass sheet with a glass enamel layer disposed on one side of it, along with an interlayer disposed adjacently to the first glass sheet and a second glass sheet adjacent to the interlayer. In one embodiment, the glass enamel layer of the article has a composition of about 0.1 to 40% by weight of polymeric energetic binders and about 0.1% to 40% by weight of at least one oxidizing agent. The glass enamel layer of the article may optionally also include about 30% to 90% by weight of a crystallizable frit, other resins, up to 30% by weight of nucleating agents, up to 40% by weight of pigment and one or more stabilizers.

The foregoing has outlined rather broadly certain features and technical advantages of the present invention. It should be appreciated by those skilled in the art that the specific embodiments disclosed may be readily utilized as a basis for modifying or designing other structures or processes within the scope of the present invention. It should also be realized by those skilled in the art, that such equivalent constructions do not depart form the spirit and scope of the invention as set forth in the appended claims.

### DETAILED DESCRIPTION

Before describing several exemplary embodiments of the invention, it is to be understood that the invention is not limited to the details of construction or process steps set forth in the following description. The invention is capable of other embodiments and of being practiced or being carried out in various ways.

In accordance with one embodiment of the present invention, a glass enamel comprises a polymeric energetic binder and an oxidizing agent, which can be applied to the second surface of a glass sheet as described above. Even though the addition of polymeric species to the enamel composition is believed to facilitate printing of the enamel, it was previously believed that the addition of polymeric binders to enamel compositions, which are to be applied to the second surface, should be avoided because the polymeric binders contain high amounts of polymers which do not burn off completely, even in the presence of the oxygen-releasing agents. According to embodiments of the invention, a viable enamel composition is provided which can be applied to the second surface of glass sheets used in windshield manufacturing. Disposition of glass enamel inks on the second surface position has been noted to result in its transfer onto surface number three (e.g. the underside of the top sheet of glass). One theory indicates that intimate contact between the glass enamel layer and glass sheets prior to complete crystallization of the frit may cause such transfer. Moreover, the corners of the glass sheets tend to experience a greater occurrence of transfer because they bear the majority of the weight during the bending process.

One embodiment of the glass enamel may comprise about 0.1 to 40% by weight of a polymeric energetic binder and about 0.1% to 40% by weight of an oxidizing agent. Other embodiments also include about 30% to 90% by weight of a crystallizable frit, resins such as EHEC and hydroxypropyl cellulose in an amount less than about 10% of the total resin content, up to 30% by weight of nucleating agents, up to 40% by weight of pigment and up to 5% of one or more stabilizers.

In accordance with an embodiment of the invention, the polymeric energetic binder is a resin more which loses about 50% or more of its weight at a temperature of about 275° C. According to one or more embodiments, this aforementioned weight loss can be measured by thermogravimetric analysis (TGA) at a constant sample heating rate of about 20° C./minute, starting at ambient temperature. Thermogravimetric Analysis (TGA) is a testing method well known in the art for characterizing such resins. The method involves heating a sample of the resin at a set heating rate (degrees C./minute) and plotting the weight loss as a function of temperature. Energetic resins typically lose large percentages of their weight at temperatures below 300° C. According to one or more embodiments, the polymeric energetic binder comprises nitrogen and/or fluorine-containing energetic moieties. Additional embodiments comprise polymeric energetic binders selected from the group consisting of nitrocellulose, glycidyl azide polymer (GAP), poly (3-nitratomethyl-3-methyl oxetane), poly (3,3-azidomethyl oxetane), poly (3-azidomethyl-3-methyl oxtane), poly(glycidyl nitrate), poly(vinylnitrate), polynitrophenylene, nitramine polyethers, and nitrated polybutadienes, and combinations thereof.

In one embodiment of the invention, it may be desirable to pre-dissolve the polymeric energetic binder in a solvent, such as butyl carbitol, prior to mixing with the enamel composition. Other embodiments utilize other solvents in which to dissolve the polymeric energetic binder.

In accordance with one embodiment of the invention, the oxidizing agent may be selected from a group consisting of peroxides, chlorates, perchlorates, nitrates, permanganates, and combinations thereof. Specific non-limiting embodiments of the invention utilize zinc peroxide or a bismuth salt of nitric acid as oxidizing agents.

According to one or more embodiments, it may be desirable to pre-disperse the selected oxidizing agent in solvents, such as butyl carbitol It will be appreciated that any solvent having an appropriate flash point and evaporation rate making it suitable for screen printing could be used as the solvent, provided it is compatible with the energetic binder(s). It will be understood that the invention is not limited to pre-dispersing the oxidizing agent in the solvent, and the oxidizing agent and a solvent can be added to the slurry with the other ingredients in one complete batch process.

One or more embodiments include a crystallizable frit in the composition to allow the pigment, if used, to bond to the glass surface during the firing and shaping step. The use of crystallizable frit further reduces the tendency of the glass enamel to stick to a second glass sheet (third surface) or other components. An example of crystallizable frit includes BASF RG112, although others are known in the art and can be substituted. Other embodiments of the invention utilize crystallizable frit. As used herein, the term “crystallizable” implies that the frit powder, after melting, can precipitate a crystalline phase upon further heating. The size and amount of the crystalline phase created is dependent on the frit chemistry, particle size and the presence of nucleating agents. While some frits do not require the use of nucleating agents, it has been found that the presence of nucleating agents often improves the properties of the enamel. The creation of crystalline phases can be confirmed via methods known in the industry such as differential scanning calorimetry (DSC), differential thermal analysis (DTA), x-ray diffraction (XRD), scanning electron microscopy (SEM) as well as optical microscopy. It has been found that washing the frit in an acid-containing medium and dried prior to incorporation will improve the viscosity stability of the glass enamel ink. However, it may be desirable according to one or more embodiments to incorporate an acid into the composition rather than washing the frit in acid.

Some embodiments use nucleating agents to control the crystallization of the crystallizable frit and to ensure the development of a semi-crystalline fired surface. Non-limiting examples of nucleating agents include bismuth silicate seed crystals, although other varieties known in the art can be substituted. The particular nucleating agents to control crystallization are dependent on the chemistry of the frits used and the desired crystal phase to be formed. Nucleating agents known to be useful in inducing crystallization for these types of enamels could include, titania and titanates, zirconia and zirconates, bismuth silicates, phosphorous and phosphates, and certain aluminates such as gahnite, and mixtures thereof.

One or more embodiments of the invention may also include other resins in addition to the polymeric energetic binder, to enhance film forming and rheological behavior of the glass enamel. Non-limiting examples of such resins include ethylhydroxyethyl cellulose (EHEC) and hydroxypropyl cellulose, although other resins known in the art may also be used. According to certain embodiments, the amount of additional resins is limited to an amount below about 10% of the total resin content.

In certain embodiments of the invention, one or more stabilizers may be employed to improve the viscosity stability. Some embodiments of the invention utilize inorganic acids such as boric acid, phosphoric acid, hydrochloric acid, nitric acid or sulphuric acid in conjunction with a nitrocellulose polymeric energetic binder. In other embodiments that utilize polymeric energetic binders, other than nitrocellulose, viscosity stability may be sufficient without the addition of a stabilizer. The skilled artisan will be able to determine an appropriate amount of stabilizer to include.

One or more embodiments of the present invention utilize pigment to impart color and opacity to the ink, such as Shepherd 430. For example, a pigment may be used in applications such as enamels used in windshield glasses discussed above. In other embodiments, a translucent finish may be desired, and thus no pigment is utilized in the composition.

In embodiments of the invention utilizing pigment, variations of the pigment particle size can be used to tailor the properties of the enamel. For example, one embodiment of the invention includes a pigment having a particle size in the range about 100 nm to 5 μm, and in a particular embodiment of about 0.25 μm to 2 μm.

According to certain embodiments of the invention, a refractory filler, such as zirconium dioxide or aluminum oxide, can be used in the composition to adjust certain properties, such as firing temperature, color, coefficient of thermal expansion, crystallinity roughness and prevent transfer of the enamel to the top sheet of glass. Other embodiments utilize metal powders in the glass enamel ink to adjust these and other properties. Refractory fillers are considered to be materials which will not melt at typical glass bending temperatures. In other words, the melting points of refractory materials should be above 750° C. Examples of refractory fillers known to those skilled in the art include, without limitation, alumina, alumina trihydrate, alumino silicates, ceria, titania, spodumene, beta-eucryptite, cordierite, talc, feldspar, silica, zircon, spinels, nitrides, borides, aluminides, and silicides. Other examples of refractory fillers include metal powders known in the art such as aluminum, boron, silicon, zinc, nickel and alloys of thereof.

According to certain embodiments, the refractory fillers have particle sizes small enough to enable the glass enamel ink to flow through a printing mesh, if applied using a screen printing process. The refractory filler particle size of other embodiments must, also, however, be large enough to prevent transfer of the glass enamel ink to other surfaces. An explanation of refractory filler particle size parameters will follow below. To satisfy these parameters, some embodiments include a refractory filler having a particle size of 75 μm or smaller. Further, other embodiments comprise refractory fillers wherein approximately 20% of the total mass has a particle size of at least 15 μm.

A non-limiting example of a suitable enamel formulation includes the following components:
62.75% by weight of BASF RG112 zinc bismuth borosilicate frit;
1.16% by weight of BASF RG123 bismuth silicate seed crystals;
14.94% by weight of Shepherd 430 black ceramic pigment;
7.11% by weight of zinc peroxide slurry having 58.6% by weight of solids and 41.35% by weight of butyl carbitol solvent;
4.69% by weight of nitrocellulose medium having 15% by weight of nitrocellulose and 85% of butyl carbitol; and
0.4% boric acid; and 9.05% butyl carbitol.

Other aspects of the invention utilize methods of application of the glass enamels described herein. After the glass enamel is mixed and dispersed in a suitable mixing or milling apparatus such as a three roll mill, bead mill, sand mill and colloidal mill to mix and disperse the glass enamel ink, the resulting paste is applied to a first glass sheet or substrate, having first and second surface positions. The paste or enamel can be applied by any suitable technique, for example, screen printing.

The glass enamel forms a film or layer that covers at least a portion of the second surface, as defined above, of the first glass sheet. The glass enamel film is allowed to dry to a uniform and defect-free finish, which, once dried, has moderate toughness or green strength. A second, uncoated glass is then placed on top of the first glass sheet. This placement disposes the glass enamel layer in between the first glass sheet and second glass sheet. The second glass sheet further has a third surface and a fourth surface, as described above. The stack of the first glass sheet and the second glass sheet, with the glass enamel ink layer isolated from exposure to air atmosphere, is heated or fired at a temperature of about 600° C. for approximately ten minutes. After cooling (annealing) the stack to room temperature, a glass enamel layer having uniform color (if pigment is included in the composition) and opacity results.

As is known in the art, the manufacture of a windshield may include further processing steps. In addition, a suitable pigment is included in the enamel composition. Thus, after forming the glass enamel layer, a windshield manufacturing process further includes insertion of an interlayer and the bonding of the glass sheets to the interlayer. In certain embodiments of the invention, the pliable interlayer layer is made of PVB. Other embodiments utilize other materials, such as metal or metal oxide wire in the interlayer.

According to other aspects of the invention, articles including glass enamels described herein are provided. The enamels are applied to various glass articles such as automobile windshields, screens for televisions, flat panel displays, computer monitors, scanners, copiers and other electronic devices. Further, the glass enamels may be applied to the fourth surface position of glass articles. In specific embodiments, glass enamels are on the second and fourth surface positions of the glass articles.

Without intending to limit the invention in any manner, the present invention will be more fully described by the following examples.

### EXAMPLES A-F

Each of the examples was prepared using a standard preparation procedure, which will be discussed below. Comparative Example A is a printing medium which uses hydroxypropyl cellulose as the primary binder. Comparative Example B uses nitrocellulose as the primary binder but does not include an oxidizing agent. Comparative Example C contains hydroxypropyl cellulose as the primary binder and also includes a zinc peroxide oxidizing agent. Example D, representing an embodiment of the present invention, uses a polymeric energetic binder of nitrocellulose as the primary binder and a zinc peroxide oxidizing agent. Example E, which represents an embodiment of the invention, uses nitrocellulose as the primary binder, zinc peroxide oxidizing agent and a boric acid stabilizer. Example F, which represents an embodiment of the invention, uses nitrocellulose as the primary binder, zinc peroxide oxidizing agent, boric acid stabilizer and zirconium dioxide as a refractory filler.

General preparation of the examples included batching and dispersion of the glass enamel ink compositions in paste form using a triple roll milling technique. After milling, the viscosity of each paste was measured with a Brookfield RVF viscometer using spindle #6 at 10 rpm at 25° C. Data derived from comparison between Comparative Examples A-C and Examples D-F will now be discussed in detail and the compositions are shown in Table 1.

TABLE 1
Composition (Percent by Weight)

| | Comp. A | Comp. B | Comp. C | D | E | F |
|---|---|---|---|---|---|---|
| RG112 crystallizable frit | 64.7 | 64.7 | 63.1 | 63.1 | 62.4 | 62.1 |
| RG123 nucleating agent | 2.4 | 2.4 | 2.3 | 2.3 | 1.9 | 2.0 |
| black ceramic pigment | 12.8 | 12.8 | 12.5 | 12.5 | 13.9 | 13.9 |
| hydroxypropyl cellulose medium | 19.8 | 0.0 | 17.8 | 0.0 | 0.0 | 0.0 |
| nitrocellulose medium | 0.0 | 19.8 | 0.0 | 17.8 | 17.0 | 16.0 |
| Surfactant | 0.3 | 0.3 | 0.2 | 0.2 | 0.2 | 0.2 |
| zinc peroxide | 0.0 | 0.0 | 4.1 | 4.1 | 4.2 | 3.5 |
| boric acid | 0.0 | 0.0 | 0.0 | 0.0 | 0.4 | 0.7 |
| zirconium dioxide | 0.0 | 0.0 | 0.0 | 0.0 | 00 | 1.6 |

### Comparison of Properties.

All of the glass enamel ink example pastes were screen printed onto a glass sheet having dimensions 100 mm×100 mm×2 mm using a 196 mesh screen. The printed portions were dried for 10 minutes at a temperature of 150° C. The printed portions were then cooled to room temperature.

Upon cooling, the printed portions were visually inspected to determine printability and toughness or green strength. A second, undecorated glass sheet having the same dimensions as the first glass sheet was placed on top of the first glass sheet to sandwich the glass enamel ink between the two glass sheets.

To simulate heat treatment of windshields and other glass composites, the stacked first and second sheets were fired in a kiln at a constant temperature of 600° C. for 9 minutes. The stack was removed and allowed to air cool. After cooling the stack was unassembled and the glass sheet carrying the affixed glass enamel ink layer was inspected and evaluated for quality both visually and using a Minolta 3700-D spectrophotometer using CIELAB color space. The spectrophotometer measures the color of the reflected light. The color statistic “L*” is a measure of the lightness or darkness of a color. A lower L* value is desirable and indicates a darker color.

To measure viscosity stability, samples of each prepared example were sealed in individual containers and held in a laboratory oven for 50° C. for a period of 3 days. Thereafter, the viscosity stability was measured using a Brookfield RVF viscometer using spindle #6 at 10 rpm at 25° C.

TABLE 2
Comparison of Glass Enamel Inks Properties

| | Comp. A | Comp. B | Comp. C | D | E | F |
|---|---|---|---|---|---|---|
| Appearance | Highly | Irregular | Irregular | Uniformly | Uniformly | Uniformly |
| of Color | irregular | color | color | dark color | dark color | dark color |
| after Firing | color | | | | | |
| Porosity | Porous | Non-porous | Porous | Non- | Non- | Non- |
| | center | center | center | porous | porous | porous |
| | | | | center | center | center |
| Decomposition | Severe | Slightly | Severe | No vapor | No vapor | No vapor |
| of Binder | vapor | reduced | vapor | transfer to | transfer to | transfer to |
| | transfer to | vapor | transfer to | top glass | top glass | top glass |
| | top glass | transfer to | top glass | | | |
| | | top glass, | | | | |
| | | when | | | | |
| | | compared to | | | | |
| | | Comparative | | | | |
| | | Example A | | | | |
| Enamel | L* = 35.0 | L* = 25.2 | L* = 20.2 | L* = 7.8 | L* = 5.20 | L* = 7.50 |
| Color | | | | | | |
| Viscosity | Stable | >90% | Stable | >90% | Stable | Stable |
| change after | | reduction | | reduction | | |
| 3 days at | | | | | | |
| 50° C. | | | | | | |

The color of Comparative Example A after firing appeared highly irregular. Moreover, evidence of porosity was detected after ink from a “Magic Marker” pen was applied to the fired glass enamel ink surface of the first glass sheet. Visual inspection of opposite side of the first glass revealed a stain caused by migration of the marker ink through the porous glass enamel ink layer. Comparative Example A also performed poorly with respect to the decomposition of the binder. The presence of vapor transfer on the second glass indicates delayed or incomplete decomposition of the hydroxypropyl cellulose binder.

Comparative Example B provided slightly better results than Comparative Example A. The substitution of hydroxypropyl cellulose with an energetic binder of nitrocellulose yielded a non-porous finish. The appearance of the color, enamel opacity and decomposition level of the binder improved slightly, while the viscosity stability deteriorated dramatically.

Comparative Example C included hydroxypropyl cellulose as the binder and a zinc peroxide oxidizing agent. However the presence of the oxidizing agent did not aid the test results. The tests of Comparative Example C yielded poor results as to color appearance, porosity and decomposition of the binder component.

Example D comprises a polymeric energetic binder of nitrocellulose and a zinc peroxide oxidizing agent. The results indicate that the use of a polymeric energetic binder significantly improved the appearance of the color, opacity and porosity of the finish. Further, the lack of vapor transfer to the top glass indicates that the polymeric energetic binder decomposed completely during firing. However, Example D performed poorly in viscosity stability testing.

From the comparison of Comparative Examples A, B, and C and Example D, the measurements clearly indicate that the addition of a polymeric energetic binder and oxidizing agent provide a superior glass enamel ink finish. Examples E and F were developed and tested to determine whether the viscosity stability of Example D can be improved upon. The addition of a stabilizer in Example E resulted in such improvement. Further, the color of the glass enamel ink also improved. Example F further includes a refractory filler of zirconium dioxide and provided better results than Example D but did not provide the superior color results of Example E.

### EXAMPLES G AND H

### Addition of Refractory Fillers

In addition to improving viscosity stability, refractory fillers may also further decrease the tendency of the glass enamel ink to transfer to the underside of the top sheet of glass (third surface) during the firing or bending of the part. To test the effectiveness of refractory fillers and to maximize the benefits of adding refractory fillers, two additional embodiments of the present invention were prepared using identical preparation procedures as Examples A, B, C, D, E and F. These examples, Examples G and H, comprised a polymeric energetic binder of nitrocellulose, a zinc peroxide oxidizing agent, an oxidizing agent and stabilizer. Examples G and F also included an aluminum oxide refractory filler having particle sizes of 10 μm and 20 μm, respectively. Further, during the firing process, a hot, 1 kg ceramic weight was placed on the top glass sheet. The test results demonstrate refractory fillers having coarser particle sizes decrease the tendency for adhesion between the glass sheets, prior to insertion of the interlayer and final bonding of the glass sheets thereto.

TABLE 3
Composition Having a Refractory Filler (Percent by Weight).

| | G | H |
|---|---|---|
| RG112 crystallizable frit | 62.1 | 62.1 |
| RG123 nucleating agent | 2.0 | 2.0 |
| black ceramic pigment | 13.9 | 13.9 |
| hydroxypropyl cellulose medium | 0 | 0 |
| nitrocellulose medium | 16.0 | 16.0 |
| surfactant | 0.2 | 0.2 |
| zinc peroxide | 3.5 | 3.5 |
| boric acid | 0.7 | 0.7 |
| aluminum oxide - (D90~10 μm) | 1.6 | 0.0 |
| aluminum oxide (D90~20 μm) | 0.0 | 1.6 |

TABLE 4
Property Comparison of Compositions with Refractory
Fillers of Varying Particle Size.

| | G | H |
|---|---|---|
| Appearance of | Uniformly dark color | Uniformly dark color |
| Color after | | |
| Firing | | |
| Surface Texture | Smooth | Slightly rough |
| Adhesiveness | Very strong adhesion | No adhesion between the |
| | between glass sheets | glass sheets |
| | leading to breakage of | |
| | the second glass sheet | |
| | upon separation | |
| Viscosity | Stable | Stable |
| change after 3 | | |
| days @ 50° C. | | |

Both Examples G and H resulted in a finish having a uniformly dark color. Example G's finish was smooth in texture while Example H's finish had a rougher texture. After firing, the two glass sheets in both examples were separated to inspect and evaluate the finish. The glass sheets carrying Example G fractured upon separation indicating strong adhesion between the glass sheets while the glass sheets carrying Example H indicated no adhesion. Although not wishing to be bound by theory, it is believed that rougher surface texture created by the coarser aluminum oxide refractory filler aids in the distribution of the weight of the top glass sheet, thereby helping to reduce the tendency of adhesion.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments. The order of description of the above method should not be considered limiting, and methods may use the described operations out of order or with omissions or additions.

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

1. A glass enamel comprising:
at least one glass frit;
a vehicle comprising a polymeric energetic binder; and
an oxidizing agent,
the polymeric energetic binder adapted to lose 50% or more of its weight when heated to a temperature of about 275° C.

2. The glass enamel of claim 1, wherein said polymeric energetic binder comprises nitrogen-containing moieties, fluorine containing moieties or combinations thereof.

3. The glass enamel of claim 1, wherein the polymeric energetic binder is a resin selected from the group consisting of Glycidyl Azide Polymer (GAP), poly (3-nitratomethyl-3-methyl oxetane), poly (3,3-azidomethyl oxetane), poly (3-azidomethyl-3-methyl oxetane), poly(glycidyl nitrate), poly(vinylnitrate), polynitrophenylene, nitramine polyethers, and nitrated polybutadienes, nitrocellulose and combinations thereof.

4. The glass enamel of claim 1, wherein the oxidizing agent is selected from the group consisting of peroxides, chlorates, percholorates, nitrates, permanganates and combinations thereof.

5. The glass enamel of claim 1, where the oxidizing agent comprises zinc peroxide.

6. The glass enamel of claim 1, wherein the glass frit comprises a crystallizable frit present in amount of about 30% to 90% by weight, the polymeric energetic binder is present in an amount of about 0.1 to 40% by weight and the oxidizing agent is present in an amount of about 0.1 to 40% by weight.

7. The glass enamel of claim 1, further comprising a resin selected from the group consisting of ethylhydroxyethyl cellulose (EHEC) and hydroxypropyl cellulose in an amount below about 10% by weight of the total resin content.

8. The glass enamel of claim 1, further comprising up to about 30% by weight of a nucleating agent.

9. The glass enamel of claim 1 further comprising a pigment present in amount of up to about 40% by weight.

10. The glass enamel of claim 9, wherein the pigment has a particle size in the range of about 100 nm to 5 μm.

11. The glass enamel of claim 1, further comprising a stabilizer selected from the group consisting of boric acid, phosphoric acid, hydrochloric acid, nitric acid and sulphuric acid.

12. The glass enamel of claim 9, further comprising a stabilizer selected from the group consisting of boric acid, phosphoric acid, hydrochloric acid, nitric acid and sulphuric acid.

13. The glass enamel of claim 8, further comprising a refractory filler.

14. A process for producing glass enamel screen printed surface comprising the steps of:
forming a glass enamel, comprising the composition of claim 1;
screen printing the glass enamel in a predetermined pattern on one side of a first glass sheet;
drying the glass enamel onto the first glass sheet;
placing a second glass sheet directly on top the first glass sheet, whereby the screen-printed layer of glass enamel is in direct contact with the second glass sheet;
firing both sheets of glass and simultaneously shaping the glass through a bending lehr;
separating the two glass sheets and inserting an interlayer; and
rejoining the two glass sheets by bonding them to each side of the interlayer so that the interlayer is in between the two glass sheets.

15. The method of claim 14, wherein the glass enamel further comprises a refractory filler having a particle size which prevents the two glass sheets from sticking to one another.

16. The method of claim 15, wherein the refractory filler is comprised of particles having a size less than 75μm.

17. The method of claim 15, wherein the refractory filler is comprised of particles having varying sizes wherein approximately 20% of the mass of the particles is larger than 15 μm.

18. An article comprising:
a first glass sheet having a first surface and a second surface;
a glass enamel layer having a composition as recited in claim 1 disposed on the second surface;
a second glass sheet having a third surface and a fourth surface, the third surface in contact with the glass enamel layer; and
a interlayer disposed in between the first glass sheet and the second glass sheet.

19. The article of claim 18, wherein the glass enamel further comprises a refractory filler having a particle size which prevents the two glass sheets from sticking to one another.

20. The article of claim 18, wherein the refractory filler is comprised of particles having a size less than 75μm.

21. The article of claim 18, wherein the refractory filler is comprised of particles having varying sizes wherein approximately 20% of the mass of the particles is larger than 15 μm.

22. The article of claim 18, wherein a glass enamel is disposed on the fourth surface.
